(19) United States
(12) Patent Application Publication
(10) Pub. No.: US 2010/0270804 A1
(43) Pub. Date: Oct. 28, 2010

(54) AIR FLOW TURBINE

(76) Inventor: Thomas Joseph Datel, Wellington (ZA)

Correspondence Address: BROOKS KUSHMAN P.C., 1000 TOWN CENTER, TWENTY-SECOND FLOOR, SOUTHFIELD, MI, 48075, US

(21) Appl. No.: 11/993,370

(22) PCT Filed: Jun. 20, 2006
(86) PCT No.: PCT/ZA2006/000080

§ 371 Date: Jul. 13, 2010

(30) Foreign Application Priority Data
Jun. 21, 2005 (ZA) 2005/5010

(51) Int. Cl. F03D 11/00

(52) U.S. Cl. 290/55

(57) ABSTRACT

The invention provides a method, an apparatus, and the use of convection air for the generation of electricity. The invention may be used on a house whereby the heat generated inside the house is used to generate electricity for use in said house.

### FIELD OF THE INVENTION

The invention relates to a wind turbine for generating electricity.

### BACKGROUND OF THE INVENTION

The inventor is aware of the need to reduce dependence on non-renewable energy resources, such as gas and coal, for the generation of electricity.

It has long been recognised that the power of the wind may be harnessed for this purpose, however, what has eluded the wind turbine industry is a solution for those windless days and for small users.

Presently electricity is generated from wind by large propeller driven generators which are unsightly, usually located on towers or high above the surrounding levels, noisy, expensive to construct and maintain, and useless when there is no wind.

The inventor has thought long and hard about the above and now proposes the following invention.

### SUMMARY OF THE INVENTION

According to a first aspect of the invention, there is provided a method of generating electricity, said method including:
harnessing heated air from a space in a roof zone of a building to drive a radial fan or turbine; and
coupling the radial fan or turbine to a generator thereby to generate electricity when the radial fan is rotated by the passage of air.
The method may include harnessing natural airflow, such as wind, to drive the radial fan or turbine.

According to a second aspect of the invention, there is provided an electricity generation apparatus, said apparatus including:
a turbine including:
   a housing;
   one or more elongate apertures in the housing;
   one or more blades;
   a shaft having an axis of rotation, the blades being rotatable about said axis of rotation;
   one or more magnet displaceable about said axis of rotation in sympathy with the rotation of the shaft;
   one or more stationary winding for interacting with the one or more magnet in the generation of electricity; and
   a support for supporting the housing, shaft, and stationary winding, said support being configured for attachment to a building.

The turbine may include blades mounted on the shaft which cause the shaft to rotate when air flows over the blades in a driving direction.

The blades may be substantially vertical which are driven either by wind from the outside of the housing or by convection of air passing from the inside of the housing to the outside through the apertures.

The housing may be dome like.

The housing may protect at least some components of the apparatus from the elements.

The turbine may be powered by convection flow of air.

The elongate apertures may be substantially vertical defining vertical blades which are driven either by wind from the outside of the housing or by convection of air passing from the inside of the housing to the outside through the apertures.

The housing may have one or more opening directed parallel to the axis of rotation to channel air into the housing.

The magnets may be mounted on a mounting which is configured to permit the flow of air through the housing thereby to cause rotation of the shaft.

The mounting may be configured to channel air flow to the blades.

The support may form an enclosure having one or more apertures so as to define a flow path for air to flow from the building to which the apparatus is attached into the housing.

The support may include a foot portion which is sized and dimensioned for attachment to a complimentary portion of a roof panel of the building, for example, to a corrugate iron sheet, or to replace one or more roof tiles.

The shaft may be mounted on the support by means of one or more bearings which are supported on the support.

The shaft may have one or more threaded portions for engaging with one or more threaded sockets on the housing and/or support.

The shaft may have one or more threaded portions for engaging with complimentary nuts for attachment of the shaft to one or both of the housing and the support.

The shaft may engage with the bearings by means of circlips.

A centrifugal braking system may be provided on the shaft for retarding the rotation of the shaft at higher speeds.

The centrifugal braking system may include one or more arms having friction members at their free ends for engaging the frame when the centrifugal force due to rotation of the shaft causes the arms to rise towards the frame.

Typically the braking system has an even number of arms, for example 2 or 4 arms, however any number of arms which do not unbalance the shaft may be used.

The friction members may be one or more wheels.

The wheels may have a natural or synthetic, organic or inorganic running surface for engaging the frame.

The windings may be combined with permanent magnets to form a permanent magnetic generator or PMG.

The windings may be connected to a rectifier having a 12V or 24V output.

An inverter may be provided to invert the rectified output from the windings to AC, for example, 220V AC.

The electricity produced may be used to charge batteries, however, the output could be used directly, if desirable.

The apparatus may include mechanical advantage means operative between the shaft and the housing to permit adjustment of the rate of rotation of the one or more magnet relative to the rate of rotation of the housing.

The mechanical advantage means may be in the form of one or more gears.

The mechanical advantage means may be in the form of a gearbox.

The mechanical advantage means may be configured to permit the one or more magnets to rotate about the axis of rotation at a higher rate than the shaft which is driven by the blades. This is especially useful under low wind and/or low convection conditions.

Conventional turbines have a nacelle to which the blades are attached, the turbine of the present invention has no nacelle thereby making the turbine efficient from all wind directions.

Thus, in use, whether or not there is wind outside, the heat inside a building, whether through environmental heating, such as sunshine heating the roof space between a roof cover and a ceiling and/or insulating layer, or artificial heating such as through the use of heaters to warm up the building's occupants, or even through the respiration of the occupants, causes the warm air to rise naturally through convection, which rising warm air is channelled into the housing of the apparatus thereby causing the housing to rotate together with the shaft and the magnets attached thereto, the relative displacement of the magnets and the windings which are fixed to the support causing a current to be generated in the windings which may optionally be rectified and applied as required.

The invention may be applied to a house, especially houses requiring electricity connection or a back up electricity supply for essential circuits.

### DESCRIPTION OF DRAWINGS OF EMBODIMENTS OF THE INVENTION

Embodiments of the invention will now be described, by way of non-limiting example only, with reference to the accompanying figures.

In the Figures,

FIG. 1 shows, in partial sectional side view, an apparatus of the embodiment;

FIG. 2 shows, in end cross section, the apparatus of FIG. 1;

FIG. 3 shows, in exploded view, the apparatus of FIG. 1; and

FIG. 4 shows, in side view, the apparatus of claim 1 installed on a roof cavity of a dwelling.

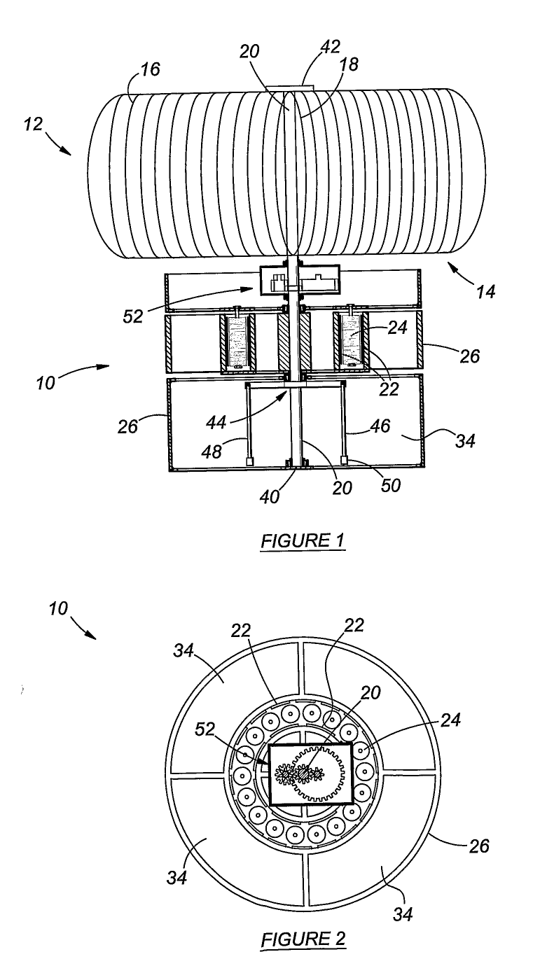

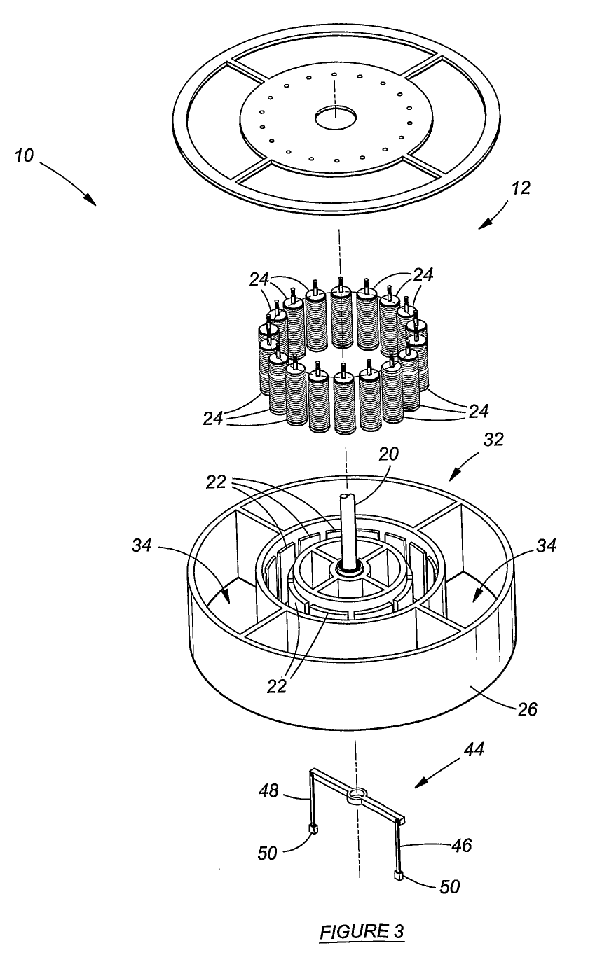

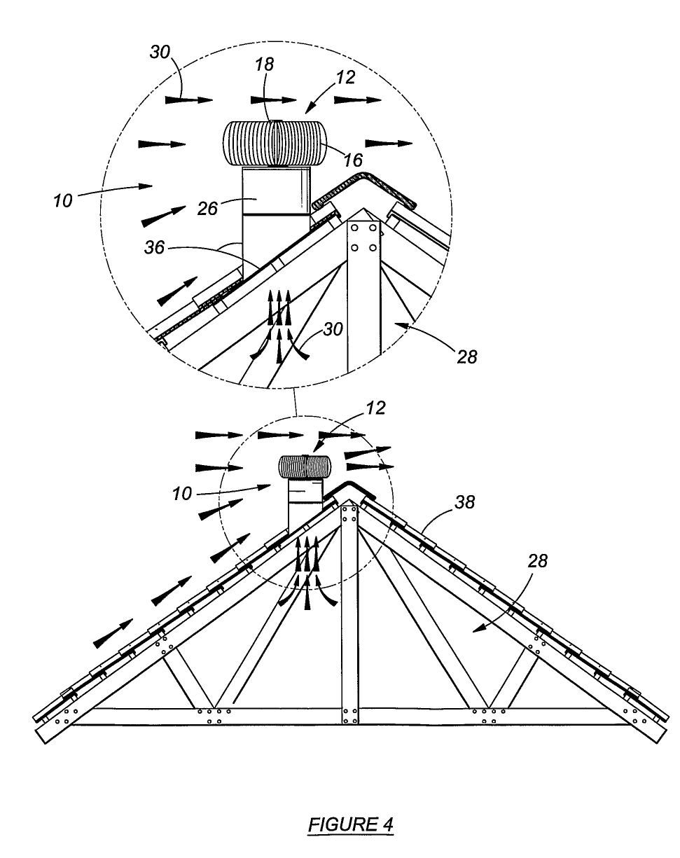

### SPECIFIC DESCRIPTION OF EMBODIMENTS OF THE INVENTION

In the description that follows a single embodiment of the invention is described. This embodiment is but one embodiment of how the invention may be performed and is, at this stage, not purported to be the best way or the only way of performing the invention known to the inventor.

In the Figures, reference numeral 10 broadly indicates an electricity generation apparatus including an air flow turbine 12 generally in accordance with the invention.

The turbine 12 including:
a housing 14 including an outer frame;
a number of elongate apertures 16 in the housing 14;
a number of blades 18 acting as sails to harness wind and/or convection air;
a shaft having 20 an axis of rotation, the blades being rotatable about said axis of rotation;
magnets 22 displaceable about said axis of rotation in sympathy with the rotation of the shaft 20;
stationary windings or spools 24 for interacting with magnets 22 in the generation of electricity; and
support 26 for supporting the housing 14, shaft 20, and stationary windings 24, said support 26 being configured for attachment to a building 28.

The turbine 12 operates when air 30 flows over the blades in a driving direction.

The blades 18 are driven either by wind 30 from the outside of the housing 14 or by convection of air 30 passing from the inside of the housing 14 to the outside through the apertures 16.

The housing 14 is dome like.

The housing 14 protects at least some components of the apparatus from the elements.

The magnets 22 are mounted on a mounting 32 which is configured to permit the flow of air through the housing 14 thereby to cause rotation of the shaft 20. The mounting 32 being configured to channel convection air flow to the blades 18.

The support 26 forms an enclosure having apertures 34 so as to define a flow path for air to flow from the building 28 to which the apparatus 10 is attached into the housing 14.

The support 26 includes a foot portion 36 which is sized and dimensioned for attachment to a complimentary portion of a roof panel 38 of the building, for example, to a corrugate iron sheet, or to replace one or more roof tiles.

The shaft 20 is mounted on the support by means of bearings 40, 42 which are supported on the support 26.

A centrifugal braking system 44 is provided on the shaft 20 for retarding the rotation of the shaft at higher speeds.

The centrifugal braking system 44 includes two arms 46, 48 having friction members 50 at their free ends for engaging the support 26 when the centrifugal force due to rotation of the shaft 20 causes the arms 46, 48 to rise towards the support 26.

The friction members 50 may be wheels (not shown).

The wheels may have a natural or synthetic, organic or inorganic running surface for engaging the frame.

The windings 24 are combined with permanent magnets 22 to form a permanent magnetic generator or PMG.

The windings may be connected to a rectifier (not shown) having a 12V or 24V output.

An inverter (not shown) may be provided to invert the rectified output from the windings to AC, for example, 220V AC.

The electricity produced may be used to charge batteries, however, the output could be used directly, if desirable (not shown).

The apparatus 10 includes a gearbox 52 operative between the shaft 20 and the housing 14 to permit adjustment of the rate of rotation of the shaft in various air flow conditions. This is especially useful under low wind and/or low convection conditions.

Thus, in use, whether or not there is wind outside, the heat inside a building, whether through environmental heating, such as sunshine heating the roof space between a roof cover and a ceiling and/or insulating layer, or artificial heating such as through the use of heaters to warm up the building's occupants, or even through the respiration of the occupants, causes the warm air to rise naturally through convection, which rising warm air is channelled into the housing of the apparatus thereby causing the housing to rotate together with the shaft and the magnets attached thereto, the relative displacement of the magnets and the windings which are fixed to the support causing a current to be generated in the windings which may optionally be rectified and applied as required.

The invention may be applied to a house, especially houses requiring electricity connection or a back up electricity supply for essential circuits.

In an embodiment of the invention the apparatus may be constructed as follows:

### Outer Frame:

| | |
|---|---|
| Diameter of outer frame: | 500 mm |
| Thickness of outer frame: | 2.0 mm |
| Height of outer frame: | 345 mm/500 mm/720 mm |
| Width of blades (sails): | 730 mm |
| Height of blades (sails): | 300 mm/500 mm |
| Total height of unit: | 625 mm/780 m/1000 mm |

### Shaft:

| | |
|---|---|
| Length: | 620 mm/775 mm/995 mm |
| Diameter | 20 mm |

The shaft is threaded to allow a nut to hold the ‘sail’ of the turbine at the top of the unit. The shaft shall also have three smooth areas to allow for sealed bearings at the bottom of the shaft and 155 mm from the bottom and 280 mm from the bottom to support the shaft. The shaft is kept in place with by fixing cir-clips to either side of the housing for the bearings.

### Gearbox:

The shaft enters the gearbox, and depending on the strength of the wind and the convection heating from within the building, the gear ratio can decreased or increased. The shaft then leaves the gearbox, spinning the PMG faster to generate more power.

### PMG (Permanent Magnetic Generator):

Manufactured of two plates 59 mm wide, the inner diameter is 174 mm. The PMG should be 2 mm thick. The diagram shows 18 ‘spools’, which will hold the wire to power the generator, the spools need to be bolted to the frame. On the outer edge of the spools, is another row of magnets, numbering 18 magnets of 75 mm high by 10 mm deep by 15 mm wide.

It will be understood by those skilled in the art that the number of spools and the number of magnets may be optimised depending on circumstances and the invention is not limited to any particular combination.

### Stator:

The stator will hold 18 magnets; the stator is constructed of two circular plates of approximately 3 mm thick with a diameter of 172.5 mm. The plates have four equidistant holes of 41 mm deep to promote air-flow the holes will start 32 mm from the center of the shaft. Within the stator is a third disk that is perforated to hold the magnets in place. The center of the, stator's circular plates are drilled with a 21 mm hole to place the shaft through the stator, the stator spins with the shaft and blades. In the center of the stator is solid metal spacer of 75 mm high, with a diameter of 50 mm to hold and support the circular plates in place. The spacer should be cut in two to place between the plates. At the top and bottom circular plates are two threaded ‘nuts’ also with a diameter of 50 mm thick to press the plates together and hold the magnets in place.

It will be understood by those skilled in the art that the number of magnets may be optimised depending on circumstances and the invention is not limited to any particular combination.

### Inner Frame:

The frame is required to hold and support the shaft; PMG and support the frame.

The inner frame comprises three plates which are designed to allow air flow through, all the plates are 2 mm thick, the first plate is at the bottom holding the bearings in a cup like frame, the second holds the PMG and bottom of the spools and the third supports the top of the spools.

The dimension of the frame is as follows:
starting at the bottom of the outer frame are on either side are 40 mm long ‘arms’ to fix the frame to the side of the outer frame.
the top and bottom of the frames are 20 mm×20 mm thick which will hold the bearings where the shaft will be supported in.
the top and bottom arms are supported by 10 mm thick ‘arms’, the PMG is fixed to this part of the frame with additional angles leaving a 85 mm/145 mm air space around the outer circumference.

### Wiring:

The wiring running from the PMG, runs to a rectifier and then out of the turbine to the batteries.
The power is 12V, 24V and can be inverted to 220V.

1.-36. (canceled)

37. A method of generating electricity, said method including:
harnessing heated air from a space in a roof zone of a building to drive a radial fan or turbine;
coupling the radial fan or turbine to a generator thereby to generate electricity when the radial fan is rotated by the passage of air; and
gearing the coupling thereby to permit the generation of electricity under heated air and/or natural airflow conditions which would be insufficient under direct coupling.

38. A method as claimed in claim 37, which includes harnessing natural airflow, such as wind, to drive the radial fan or turbine.

39. An electricity generation apparatus, said apparatus including:
a turbine including:
a housing;
one or more elongate apertures in the housing;
one or more blades;
a shaft having an axis of rotation, the blades being rotatable about said axis of rotation;
one or more magnet displaceable about said axis of rotation in sympathy with the rotation of the shaft;
one or more stationary winding for interacting with the one or more magnet in the generation of electricity;
a support for supporting the housing, shaft, and stationary winding, said support being configured for attachment to a building;
wherein the turbine includes blades mounted on the shaft which cause the shaft to rotate when air flows over the blades in a driving direction and the elongate apertures being substantially vertical defining vertical blades which are driven either by wind from the outside of the housing or by convection of air passing from the inside of the housing to the outside through the apertures;
wherein the housing has one or more opening directed parallel to the axis of rotation to channel air into the housing, the magnets being mounted on a mounting which is configured to permit the flow of air through the housing thereby to cause rotation of the shaft; and
including a centrifugal braking system provided on the shaft for retarding the rotation of the shaft at higher speeds.

40. An apparatus as claimed in claim 39, wherein the blades are substantially vertical and which are driven either by wind from the outside of the housing or by convection of air passing from the inside of the housing to the outside through the apertures.

41. An apparatus as claimed in claim 39, wherein the housing is dome like.

42. An apparatus as claimed in claim 41, wherein the housing protects at least some components of the apparatus from the elements.

43. An apparatus as claimed in claim 44, wherein the mounting is configured to channel air flow to the blades.

44. An apparatus as claimed in claim 39, wherein the support forms an enclosure having one or more apertures so as to define a flow path for air to flow from the building to which the apparatus is attached into the housing.

45. An apparatus as claimed in claim 39, wherein the support includes a foot portion which is sized and dimensioned for attachment to a complimentary portion of a roof panel of the building, wherein the foot portion is configured to replace a roof tile, a portion of a metallic roof sheet, or be a covering for any other roof covering.

46. An apparatus as claimed in claim 39, wherein the shaft is mounted on the support by means of one or more bearings which are supported on the support.

47. An apparatus as claimed in claim 46, wherein the shaft has one or more threaded portions for engaging with one or more threaded sockets on the housing and/or support.

48. An apparatus as claimed in claim 46, wherein the shaft has one or more threaded portions for engaging with complimentary nuts for attachment of the shaft to one or both of the housing and the support.

49. An apparatus as claimed in claim 39, wherein the shaft engages bearings by means of circlips.

50. An apparatus as claimed in claim 49, wherein the centrifugal braking system includes one or more arms having friction members at their free ends for engaging the frame when the centrifugal force due to rotation of the shaft causes the arms to rise towards the frame.

51. An apparatus as claimed in claim 49, wherein the friction members are one or more wheels which have a natural, synthetic, organic, and/or inorganic running surface for engaging the frame.

52. An apparatus as claimed in claim 39, wherein the windings are combined with permanent magnets to form a permanent magnetic generator.

53. An apparatus as claimed in claim 39, including a gearbox operative between the shaft and the housing to permit adjustment of the rate of rotation of the one or more magnet relative to the rate of rotation of the housing, wherein the gearbox is configured to permit the one or more magnets to rotate about the axis of rotation at a higher rate than the shaft which is driven by the blades.

54. An apparatus as claimed in claim 39, wherein the blades are nacelleless.

55. Use of heat generated inside a building for the generation of electricity, wherein independent of outside wind conditions, the heat inside a building causes the warm air to rise naturally through convection, which rising warm air is channelled into the housing of an apparatus as claimed in claim 1, thereby causing the housing to rotate together with the shaft and the magnets attached thereto, the relative displacement of the magnets and the windings which are fixed to the support causing a current to be generated in the windings, wherein the heat generated inside the building is generated through one or more processes selected from the group including environmental heating, sunshine, artificial heating, heaters to warm up the building's occupants, and respiration of the occupants.
